(19) United States
(12) Patent Application Publication
(10) Pub. No.: US 2024/0416340 A1
(43) Pub. Date: Dec. 19, 2024

(54) FLUID INPUT MODULE FOR MICROFLUIDIC DEVICES

(71) Applicant: Wainamics, Inc., Pleasanton, CA (US)

(72) Inventors: Arturo Escajeda, Oakland, CA (US); Amanda Giacobbe, San Jose, CA (US); Ming X. Tan, San Ramon, CA (US)

(73) Assignee: Wainamics, Inc., Pleasanton, CA (US)

(21) Appl. No.: 18/699,972

(22) PCT Filed: Oct. 7, 2022
(86) PCT No.: PCT/US2022/045998

§ 371 Date: Apr. 10, 2024

Related U.S. Application Data
(60) Provisional application No. 63/257,708, filed on Oct. 20, 2021.

(51) Int. Cl. B01L 3/00

(52) U.S. Cl. CPC B01L 3/502715; B01L 3/523; B01L 2200/027; B01L 2300/044; B01L 2300/0672; B01L 2300/0681

(57) ABSTRACT

The invention is directed to an input module for microfluidic cartidges comprising: (a) a container for holding a fluid, the container comprising an interior and an inlet thereto; (b) a cap comprising a tubular body with an axial passage such that a first end of the axial passage is capable of being sealingly connected to the inlet of the container and a second end of the axial passage is sealingly covered with a pierceable film and comprises a cap fitting; and (c) an inlet operationally associated with a microfluidic device.

An on-going challenge for the practical application of microfluidic devices, especially in medical settings, is the preparation and insertion of a sample or reagent into a microfluidics device without loss, spillage or contamination. This is sometimes referred to as the “macro-to-micro” or “world-to-chip” interface challenge, e.g. Fredrickson et al, LabChip, 4:526-533 (2004); Oh et al, LabChip, 5:845-850 (2005); and the like. Presently, there are no standard input modules or methodologies with industry-wide acceptance; instead, there have been a variety of techniques employed for delivering fluids to microfluidics chips that are (or have been) adopted on an ad hoc basis to fit the experimental needs at hand, e.g. Fredrickson et al (cited above)

It would be highly desirable, especially for medical applications, if there were available simple and cost-effective modules and methods for convenient and effective loading of fluids, such as patient samples, into microfluidics devices, wherein such modules have minimal design requirements for industry-wide applicability.

### SUMMARY OF THE INVENTION

The invention is directed to modules, and methods using such modules, for loading fluids into, or transferring fluids to, a microfluidic device.

In one aspect, the invention is directed to an input module for microfluidic cartridges comprising: (a) a container for holding a fluid, the container comprising an interior and at least one inlet thereto; (b) a cap comprising a tubular body with an axial passage wherein (i) a first end of the axial passage sealingly connects to an inlet of the container, (ii) a pierceable film sealingly covers a second end of the axial passage, and (iii) the second end of the axial passage comprises a cap fitting; and (c) an inlet operationally associated with a microfluidic device comprising an inlet fitting capable of connecting to and forming an air tight seal with the cap fitting, the inlet having a planar region comprising at least one inlet port for accepting fluid from the container and an outlet port for inserting a driving fluid into the container to force fluid to exit the container through the inlet port, wherein the inlet port and the outlet port are spaced apart within the planar region and each comprise a piercing element, wherein each piercing element has a pointed shape protruding from the planar region such that whenever the cap fitting and the inlet fitting are engaged the piercing elements of the planar region are forced into contact with and pierce the pierceable film, thereby allowing driving fluid to enter the interior of the container and to force fluid from the container to enter the inlet port of the inlet. In various embodiments, a driving fluid may comprise a gas or a liquid. In some embodiments, a driving fluid which is a liquid may be immiscible with the fluid in the container, In some embodiments, a driving fluid may comprise an assay reagent.

In one aspect, modules of the invention are used with a single-use device, or cartridge, comprising a microfluidics circuit for performing a bioassay on a biological sample in order to determine in conjunction with an associated appliance the presence or quantity of one or more biomolecules, such as one or more polynucleotides. The associated appliance is a multi-use device that provides thermal sources, pressure and vacuum sources, valving, mechanical actuators, detection stations, and the like, to enable a bioassay on the single-use cartridge. In some embodiments, during operation the top and the bottom of a cartridge is aligned with the direction gravity; or, in other words, in operation, a cartridge is oriented vertically with its top uppermost, so that gravity drives fluids in a particular direction with respect to a microfluidic circuit in the cartridge.

These above-characterized aspects, as well as other aspects, of the present invention are exemplified in a number of illustrated implementations and applications, some of which are shown in the figures and characterized in the claims section that follows. However, the above summary is not intended to describe each illustrated embodiment or every implementation of the present invention.

### BRIEF DESCRIPTION OF THE DRAWINGS

FIGS. 1A-1B illustrate diagrammatically how a microfluidics cartridge and an appliance of the invention operate together.

FIGS. 2A-2B exemplify the connection of a module of the invention to a microfluidics cartridge.

FIGS. 2C-2D illustrate further embodiments of containers of fluid input modules.

FIG. 2E illustrates an embodiment of a fluid input module comprising a container with multiple reagent compartments and a plurality greater than two of piercing elements.

FIG. 2F illustrate an exemplary embodiment of a container comprising four compartments.

FIG. 2G illustrates the operation of a rigidity plate to facilitate the puncturing of the pierceable film when the cap and inlet fittings are fully engaged.

FIGS. 3A-3E illustrate to operation of an exemplary microfluidics device employing a module of the invention.

FIG. 4 illustrates a microfluidics cartridge adapted for use with two fluid input modules, e.g. one for sample and one for a bioassay reagent.

FIG. 5 illustrates an exemplary microfluidics device whose fluid input module further includes a vacuum port for pulling the pierceable film to the planar surface of the microfluidics inlet.

FIG. 6 illustrates two exemplary caps for use with the module of the invention.

FIGS. 7A-7C illustrate exemplary piercing elements for use with modules of the invention.

### DETAILED DESCRIPTION OF THE INVENTION

The general principles of the invention are disclosed in more detail herein particularly by way of examples, such as those shown in the drawings and described in detail. It should be understood, however, that the intention is not to limit the invention to the particular embodiments described. The invention is amenable to various modifications and alternative forms, specifics of which are shown for several embodiments. The intention is to cover all modifications, equivalents, and alternatives falling within the principles and scope of the invention. Guidance for selecting materials and components to carry out particular functions may be found in available treatises and references on scientific instrumentation including, but not limited to, Moore et al, Building Scientific Apparatus, Third Edition (Perseus Books, Cambridge, MA); Hermanson, Bioconjugate Techniques, 3rd Edition (Academic Press, 2013); and like references.

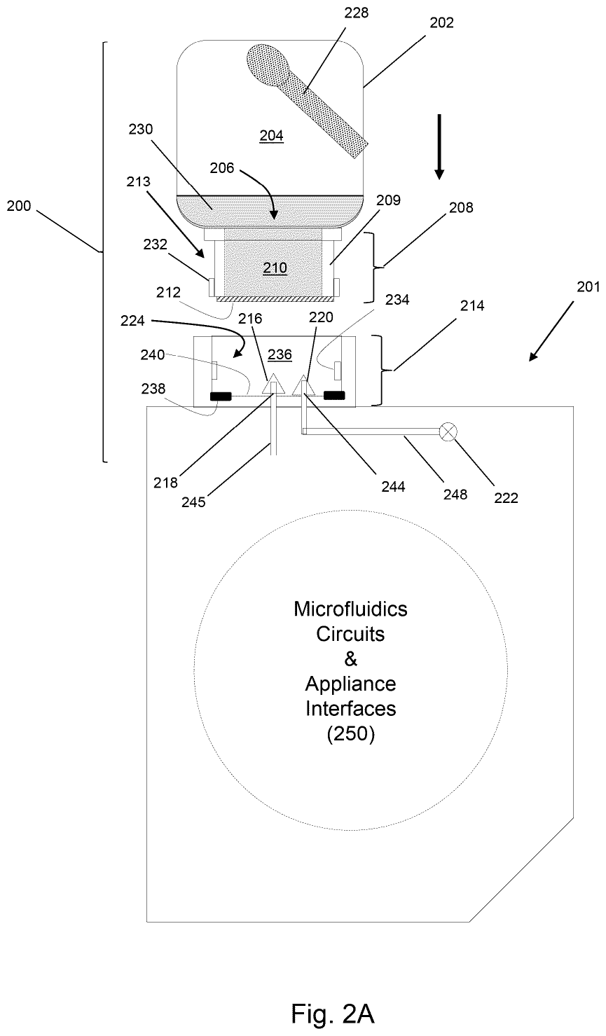

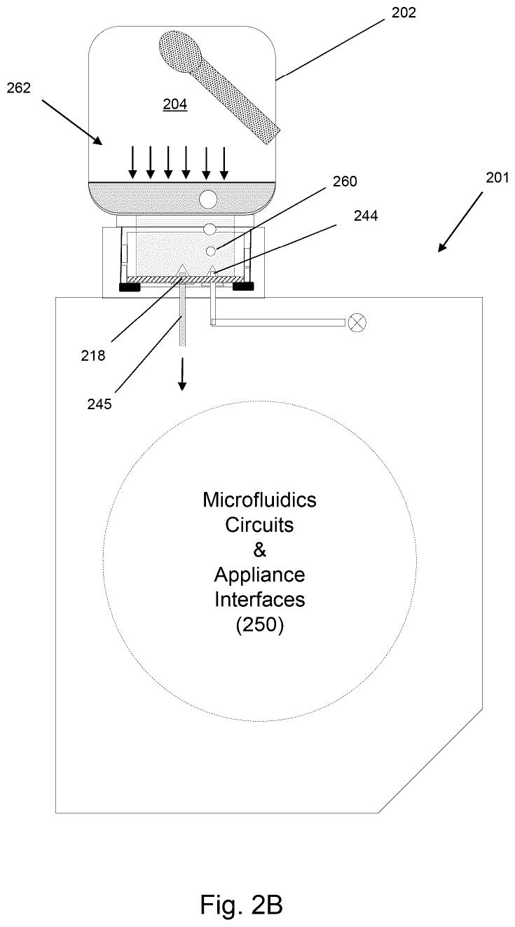

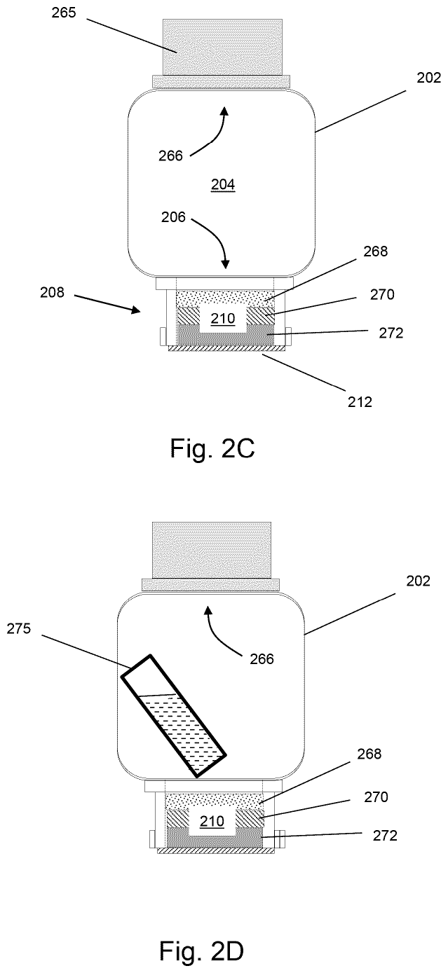

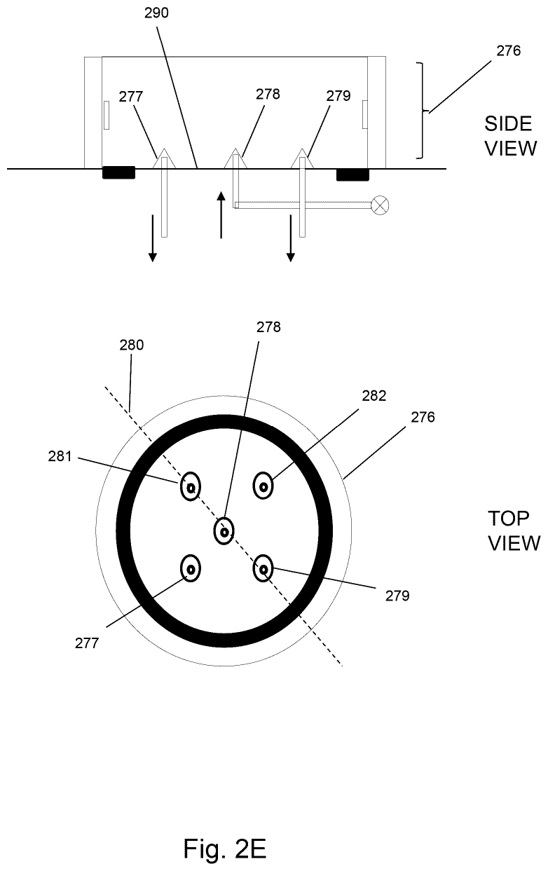

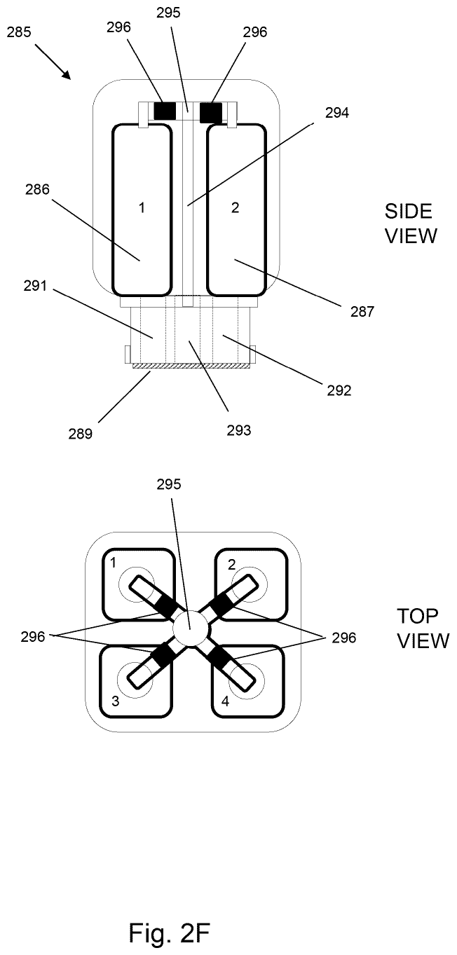

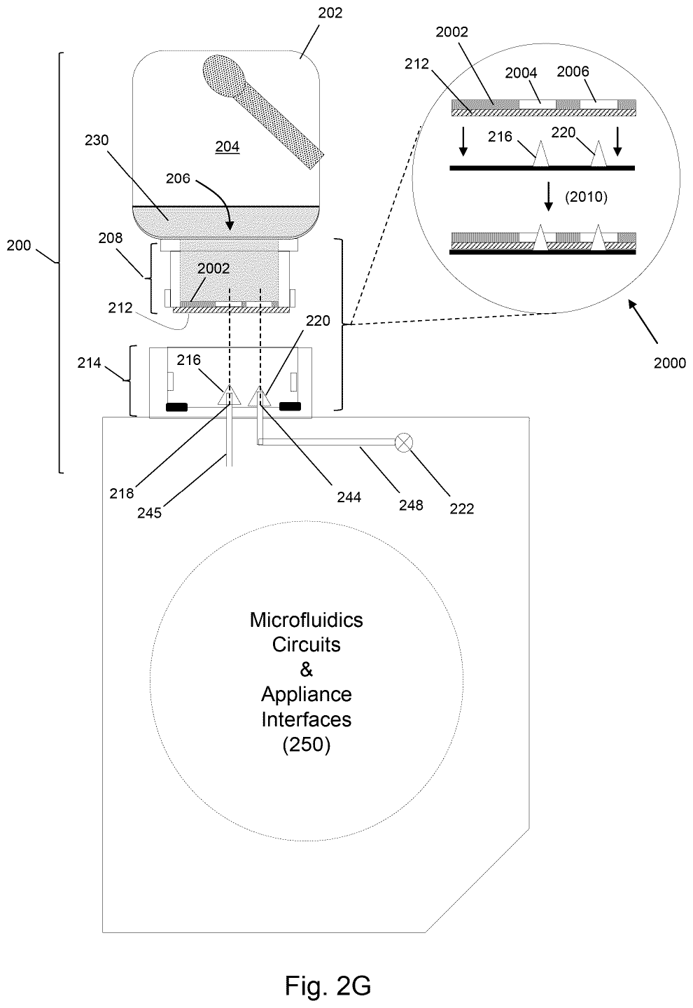

The invention is directed to methods and structures for loading or transferring fluids to a microfluidic device from an external container. Such fluids may consist of, or contain a sample, or may be derived from a sample. Or such fluids may consist of, or contain, an assay reagent, or the like. In one aspect, the invention provides a module for use with a microfluidic device wherein the module provides a container for a fluid to be inputted, which container has a cap adapted for conveniently transferring contents of the container to an inlet port of a microfluidics device. In some embodiments, a module of the invention comprises three components: a container, a cap and a microfluidics inlet, the latter of which may be an integral component of the microfluidics device of a cartridge, or like structure containing a microfluidics circuit. In some embodiments, the microfluidics device operates with an associated external appliance, e.g. Chen et al, Biomed. Microdevices, 12 (4): 705-719 (2010). Typically, the associated appliance is a multi-use device that provides thermal sources, pressure and vacuum sources, mechanical actuators, and a detection station to enable an assay, such as a bioassay, to be conducted on a single-use cartridge. In some embodiments, during operation the module of the invention is positioned on a cartridge and aligned with the direction gravity so that gas (for example) inserted into the container is disposed above the fluid and pushes the fluid down through an inlet port as gas is dispensed into the scaled container (e.g. as illustrated in FIGS. 2A-2B). In some embodiments, a fluid input module may have different positions or orientations on a cartridge from those illustrated in FIGS. 2A-2B. For example, a fluid input module and inlet may be perpendicular to the plane of a cartridge, and a cartridge may have a vertical orientation (with respect to gravity) during operation or a horizontal orientation (with respect to gravity) during operation.

Modules of the invention are particularly useful for point-of-care bioassays conducted in low-cost disposable assay cartridges comprising a microfluidics device (or circuit) and an appliance into which the cartridge may be inserted and operationally connected to provide (as mentioned above) external physical motive forces (e.g. pressure or vacuum sources, agitation, or the like), heat sources, and detection and readout systems for the bioassays performed in the cartridges. By such connections to the appliance, the need to provide cartridges with on-board valves, pumps, independent power sources, or the like, is reduced or obviated, thereby drastically reducing manufacturing costs.

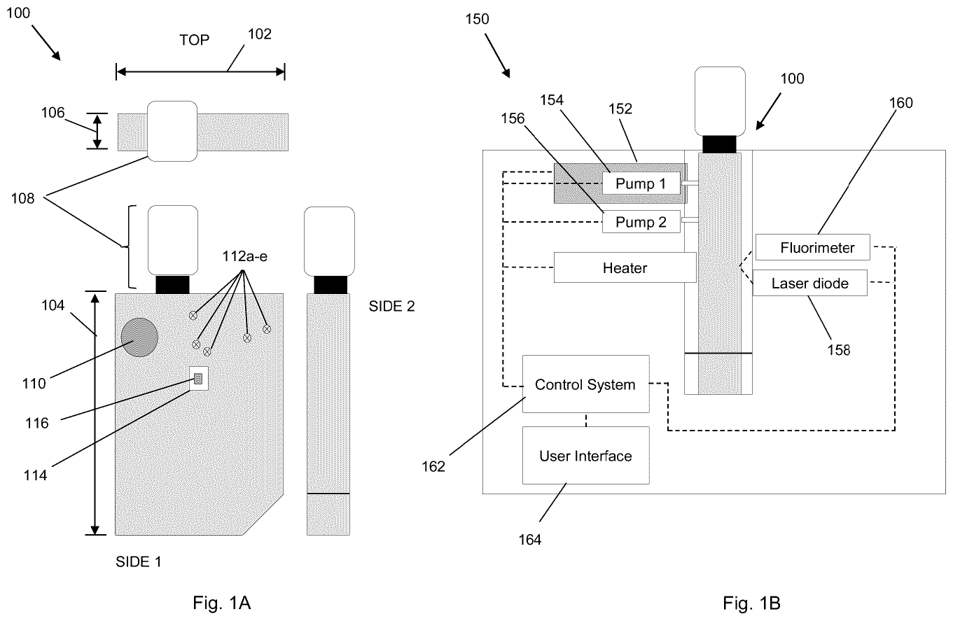

An exemplary cartridge (not showing an associated fluid input module) and appliance for conducting an isothermal amplification bioassay for detecting a polynucleotide in a sample are illustrated in FIGS. 1A-1B. As further illustrated in FIGS. 2A-2C, a fluid input module of the invention (108) of FIGS. 1A-1B inserts or is attached to a cartridge (or other structure) containing a microfluidic circuit. The complexity and dimensions of a cartridge may vary widely and depend in part on the complexity of fluidic movements and operations required to conduct an analytical or other procedure for which it is intended. For example, multiple different bioassays may be carried out on different biomolecules from the same sample, or a single bioassay may be carried out on multiple different species of a single type of biomolecule, e.g. multiple species of DNA or RNA. In some cases, target polynucleotides may all be amplified in an amplification chamber prior to detection or quantification of some or all the target polynucleotides in the same chamber as the one in which amplification took place. In other embodiments, detection or quantification of amplified target polynucleotides may take place in a chamber different from the amplification chamber. In still other cases, detection or quantification of the amplified target polynucleotides takes place in a different chamber (for example, after separate amplification) for each different target polynucleotide. In some cases, detection or quantification may require additional reagents (i.e., “detection reagents”) different from the reagents used in an amplification reaction.

FIG. 1A depicts an exemplary cartridge (100) for carrying out a bioassay for a single biomolecule, such as a DNA or RNA, which has attached a fluid input module (108) of the invention. In some embodiments, dimensions of such a cartridge may be in the range of from 1-4 cm width (102), 2-8 cm height (104) and 0.5-1 cm depth (106). In some embodiments, cartridges have a single sample chamber with an opening at the top of the cartridge design to receive a sample, after which the opening is capped with cap (108) to form a liquid-tight seal. In some embodiments, container of input module (108) may have a volume (or fluid holding capacity) in the range of one or a few microliters (e.g. 1 μL, or 10 μL) to several milliliters (e.g. 100 mL, or 10 mL, or 1 mL). Cartridges may have multiple ports that establish pneumatic, optical and physical connections with an appliance. Appliance designs may vary widely to accommodate different cartridge designs. As shown in FIGS. 1A-1B, the fluid input module is exterior to the appliance in the operable configuration. In some embodiments, a fluid input module may be interior to, and interact with, an appliance, for example, for the purpose of applying heat, agitation, or other inputs, to the fluid input module. Returning to FIG. 1B, after insertion of cartridge (100) into appliance (150) side 1 of cartridge (100) includes blister pouch (or pack) (110) that aligns with actuator (152) (behind pump 1), vent ports (112a, 112b, 112c, 112d, 112c) align with pump 1 (154) and pump 2 (156) and the rest align with valves that open or close either to allow air passage through the vent ports or to block air passage through the vent ports. In some embodiments, vent ports may align and sealingly connect with a three-way valve having a passage that leads to a pump, a passage that leads to a vent, and a passage that leads to the cartridge. Window (114) that aligns with laser diode (158) and fluorometer (160) permits optically based detection or measurement of a signal from detection chamber (116) of cartridge (100). Thermal source (161) maintains the detection chamber at a predetermined temperature in the case of an isothermal bioassay or thermal cycles a reaction mixture in the detection chamber in the case of, for example, a real time PCR. Appliance (150) further includes control system (162) comprising a computer for controlling (i) initiation of lysis buffer release, e.g. by having actuator (152) rupture blister pouch (110), (ii) actuation of pumps and valves, (iii) actuation of the signal detection components, (iv) collection and storage of data, (v) transmitting bioassay results to the user, e.g. via user interface (164). As described more fully below, a vent port (e.g. one of 112a-c) may be operationally associated with fluid input module (108) for introducing gas into the container of module (108). As used herein, the term “sealingly” in reference to port or fitting connections means that the connections are capable of permitting transfer of fluids or gas without leakage when such fluids or gas are under moderate pressure, such as, in a range of from 0.5 to 10 psi.

In some embodiments, an appliance may also include a heating or thermal control component for maintaining either a detection chamber a predetermined temperature, e.g. for an isothermal amplification assay, or for cycling an amplification chamber among several temperatures, e.g. for performing a polymerase chain reaction. In embodiments employing an isothermal bioassay, a predetermined temperature in the range of from 55° C. to 70° C. is employed, and in some embodiments, a predetermined temperature in the range of from 60° C. to 65° C. is employed. For a bioassay employing CRISPR-based detection, a detection chamber may be held in a predetermined temperature in the range of from 30° C. to 60° C.; or in some embodiments, a predetermined temperature in the range of from 32° C. to 40° C. For a PCR based reaction, temperature may be cycled between 40 to 99° C. Additional heating units may be deployed to heat the reagent chamber to melt wax barriers for releasing assay reagents or to heat the mixing chamber to maintain the wax in a melted state.

FIGS. 2A-2B illustrate the operation of an embodiment of a fluid input module of the invention. Module (200) associated with cartridge (201) comprises (i) container (202) with interior (204) and inlet (206); cap (208) with axial passage (210) between inlet (206), pierceable film (212) and (male) snap-on cap fitting (213); and (iii) microfluidics inlet (214) with (female) snap-on inlet fitting (224). Microfluidics inlet (214) comprises gasket (238) and at least a first piercing element (216) associated with inlet port (218) and a second piercing element (220) associated with a gas or fluid source, which is controlled by a valve associated with port (222) (the valve typically residing in an appliance). Gasket (238) illustrated in cross section may be a flat annular shaped gasket that forms an air tight axial seal between the rim of fitting (213) (which may include pierceable film (212)) and microfluidics inlet (214). In some embodiments, gasket (238) may be recessed in microfluidics inlet (214) so that pierceable film (212) butts against planar region (240) whenever the snap-on fittings are engaged (thereby assisting the puncturing and penetration of the pierceable film by the piercing elements). One of ordinary skill would recognize that other gasket configurations may be employed, such as, O-ring gaskets providing a radial seal. One of ordinary skill would also recognize that liquids in container (202) may be transferred to cartridge (201) by vacuum as well as positive pressure as illustrated in FIG. 2B. Cap (208) may comprise a tubular body (209) with axial passage (210). Tubular body (209) may be cylindrical or have a triangular, square, pentagonal, hexagonal, or like, cross-section, wherein the selection of the cross-section of the tubular body is consistent with the nature of the cap and inlet fittings. In some embodiments, tubular body (209) has a cylindrical cross-section.

In some embodiments, as illustrated in FIG. 2G, rigidity plate (2002) may be disposed behind pierceable film (212) with respect to inlet (214). The purpose of rigidity plate (2002) is to prevent pierceable film from flexing or distending without puncturing when piercing elements (216) and (220) are forced against it. Rigidity plate (2002) comprises a rigid flat material with holes (e.g. 2004 and 2006) at positions corresponding to the sites at which the pierceable elements (216 and 220, respectively) contact the pierceable film. The geometry and area of the holes are selected to accommodate the piercing elements so that whenever the cap and inlet fittings are fully engaged the piercing elements align with and insert into the holes in a manner that allows piercing of the pierceable film. One of ordinary skill would recognize that a rigidity plate need to have a hole only where piercing elements contact the pierceable film and that such a plate could include more holes or could allow flexing or distension of the pierceable film away from the pierceable elements. The operation of a rigidity plate (2002) is illustrated in blow-up (2000). The engagement of the cap fitting and inlet fitting aligns each piercing element with a hole, so that after full coupling (2010) the pierceable film (212) is punctured in the areas corresponding to the locations of the holes in the rigidity plate

Although snap-on fittings are illustrated in the figures, cap fittings and inlet fittings may have a variety of formats including, but not limited to, snap-on fittings, threaded fittings, and interference fittings and may include external components, such as, screw drives, levers, clamps, or other actuators, to force a container and cap onto the piercing elements of the inlet to facilitate piercing of the pierceable film. In some embodiments, cap fittings and inlet fittings are snap-on fittings.

Returning to FIGS. 2A-2B, container (202) is illustrated with swab (228) and fluid (230) that may, for example, comprise a patient sample deposited into a sample preparation solution, such as a lysis buffer. Alternatively or additionally, a fluid, such as a lysis buffer may be introduced into container (202) after attachment by way of an outlet (in addition to an outlet for transferring gas to interior (204)) and piercing element of the planar region of the microfluids inlet. Further, with the appropriate appliance, heat and/or agitation may be applied to container (202). Snap-on fitting (213) is illustrated as a male complementary fitting to female snap-on fitting (224) of microfluidics inlet (214). In other embodiments, the male snap-on fitting may be associated with microfluidics inlet (214) of cartridge (201) and the female snap-on fitting may be associated with cap (208). The snap-on fittings may have a wide variety of designs subject to the requirement that upon engagement (or connection) a secure airtight seal is formed. In some embodiments, the engagement of the snap-on fittings produces an essentially irreversible, or auto-locking, connection between microfluidics inlet (214) and cap (208), which cannot be disengaged without the aid of tools or breaking. Generally the snap-on fittings are engaged manually by applying moderate axial force readily provided by a user of normal strength, e.g. 1-10 newtons.

In the example of FIGS. 2A-2B, the snap-on functionality is provided by outward facing annular collar (232) integral with cap (208) and inward facing annular collar (234) integral with microfluidics inlet (214). For example, cap (208) and microfluidics inlet (214) may be constructed of an elastomeric material that permits temporary deformation of microfluidics inlet (214) whenever cap (208) is axially forced into barrel (236) of microfluidics inlet (214) to form a mated, or connected, configuration (shown in FIG. 2B). Outward facing annular collar (232) and inward facing annular collar (234) are illustrated as having rectilinear cross sections, but one with ordinary skill in the art would recognize that such collars may have rounded or beveled sides to make engagement of the fittings easier. After outward facing annular collar (232) is forced past inward facing annular collar (234) it seats in the cavity between annular collar (234) and gasket (238), after which the temporarily deformed cap (208) relaxes to lock annular collar (232) in place and form an airtight seal between (e.g. sealingly connects) cap (208) and gasket (238). Those of ordinary skill will recognize that snap-on connectors of many different formats may be employed to accomplish the same function in modules of the invention. Representative snap-on connectors are described in the following references which are incorporated by reference: U.S. Pat. Nos. 3,540,760; 4,105,226; 5,161,834; 7,841,629; and U.S. patent publication 20160369922.

Microfluidics inlet (214) comprises planar region (240) in which inlet port (218) and outlet port (244) are disposed. In some embodiments, planar region (240) is coextensive with the interior space of annular gasket (238) Inlet port (218) is connected by passage (245) to microfluidic circuits (250) of cartridge (201). Microfluidic circuits (250) may of course vary widely in design and function. Outlet port (244) is connected by passage (248) to vent port (222), which may be sealingly connected to a pressure source in an associated appliance via a valve (not shown). Inlet port (218) and outlet port (244) are operationally associated with piercing elements (216) and (220), respectively, shown as triangular shapes. Piercing elements (216) and (220) produce holes or openings in pierceable film (212) by or adjacent to inlet port (218) and outlet port (244), respectively, whenever the snap-on fittings of cap (208) and microfluidics inlet (214) are engaged, i.e. connected. The shape of piercing elements (216) and (220) may vary widely and may be the same or different, and may depend on the composition of pierceable film (212). In some embodiments, pierceable film is a metal foil, such as aluminum foil, mylar, or like film, that may be sealingly attached to the end of cap (208) by gluing, heat sealing, or the like. As described more fully below, fluid input modules of the invention may comprise a plurality of piercing elements and associated inlets or outlets. For example, a fluid input module may comprise a single piercing element associated with an outlet for introducing gas (or fluid) into one or more containers as well as one or more piercing elements each associated with a different inlet for accepting different fluids from a container having one or more compartments.

As shown in FIG. 2B, when the snap-on fittings of cap (208) and microfluidics inlet (214) are connected, inlet port (218) and outlet port (244) become fluidly connected with (i.e. are placed in fluid communication with) interior (204) of container (202). Fluid transfer is carried out by introducing gas (260) (shown as bubbles in the figure) into interior (204) of container (202) (which is oriented in gravity so that fluid (230) is in cap (208)). The introduced gas creates a pressure head in interior (202) which pushes (262) fluid (230) through inlet (218) and into passage (245) and into the microfluidics circuits of cartridge (201). Gas may also be inserted for the purpose of mixing reagents and/or samples in the compartments or container. Additionally or alternatively, in some embodiments, outlet port (244) may introduce a liquid into interior (204) to create a pressure head. For example, an immiscible liquid may be introduced, such as, an oil, or a miscible liquid may be introduced, such as, a lysis buffer.

In some embodiments, container (202) may have additional elements for implementing sample preparation and analysis. Several such elements are illustrated in FIGS. 2C and 2D. Container (202) may have second cap (265) and second inlet (266), for example, at an end opposite to that of cap (208) and inlet (206). Such second inlet (266) may be used to insert additional reagents and/or samples. In some embodiments, container (202) may be open. That is, it may have a second inlet without a cap or cover. In such embodiments, container (202) may be attached to cartridge (201, not shown) after which a sample or other fluids may be added. After such additions, the inlet may be closed by applying (for example) an adhesive film. In some embodiments, one or more of the following elements may be selected for disposition in axial passage (210): (i) dissolvable film (268), (ii) dried reagents (270), and (iii) filter (272). The order and number of such elements are design choices depending on the nature of the assay implemented and the kind of sample being analyzed. Alternatively or in connection with the above, a matrix, such as, porex may be employed which releases reagents into container (202) upon exposure to a sample and/or other reagents.

As illustrated in FIG. 2D, in some embodiments, an additional reagent may be introduced to a sample by providing vial (275) inside container (202) which may be crushed to release the reagent. In such embodiments, one with ordinary skill would recognize that the shape and flexibility of the wall of container (202) is selected to facilitate crushing of vial (275). In some embodiments, a sample may be added through inlet (266) after which the sample dissolves dissolvable film (268) (e.g. EcoCortec (Manastir, Croatia) to permit the sample to mix with dry reagents (270) (e.g., lysing solution/DNA extraction buffer). After an appropriate incubation with possible heating, glass vial (275) may be broken to expose the sample mixture to a different set of reagents (such as, a pH neutralization solution such as NaOH, solvents such as alcohol, phenol, chloroform, Rnase, Proteinase K, etc). After further incubation with possible heating, container (202) is connected to a microfluidics device (via snap-on fittings) after which gas is dispensed to interior (204) of container (202) to push the sample mixture through filter (272) and into the microfluidics circuit for analysis.

As mentioned above, in some embodiments, fluid input modules may have a plurality of piercing elements greater than two: at least one serving as an outlet for inserting a gas into one or more compartments of a container and at least two serving as inlets each operationally associated with separate compartments of the container. Top and side views are illustrated in FIG. 2E for such an embodiment comprising one outlet piercing element and four inlet piercing elements. In the side view (along plane 280), planar region (290) of microfluidics inlet (276) is shown with inlet piercing elements (277) and (279) and outlet piercing element (278). In the top view of microfluidics inlet (276), all five piercing elements (277, 278, 279, 281 and 282) are shown. One of ordinary skill would recognize that the fittings of microfluidics inlet (276) and the cap of the container (not shown) would include an orienting guide which would serve to align the fittings so that each inlet piercing element is aligned with its respective reagent compartment. For snap-on fittings, an exemplary orienting guide may comprise a ridge on one fitting that aligns with and inserts into a groove in the other fitting, so that connection of the fittings required alignment of the ridge and groove, thereby assuring alignment of the piercing elements with their respective compartments. FIG. 2F illustrates an exemplary container (285) comprising four compartments (labeled 1 (286), 2 (287), 3 and 4) which may be used with a corresponding microfluidics inlet having four inlet piercing elements, such as illustrated in FIG. 2E. Each compartment includes a passage to pierceable film (289), for example, as shown by passage (291) and (292) for compartment 1 (286) and compartment 2 (287), respectively, in the side view. Gas may be selectively inserted into the compartments through an outlet port associated with outlet piercing element aligned with passage (293) (which, for example, could be piercing element (278) of FIG. 2E). Gas from the output port would travel through passages (293) and (294) to hub (295). Hub (295) is connected to each of the compartments by a separate passage. In some embodiments, each of the separate passages is blocked by wax barrier (296) that may be selectively removed by heating. Thus, gas is selectively distributed to each container in a predetermined order by applying heat (for example, via an appropriate appliance) to each wax barrier in the predetermined order.

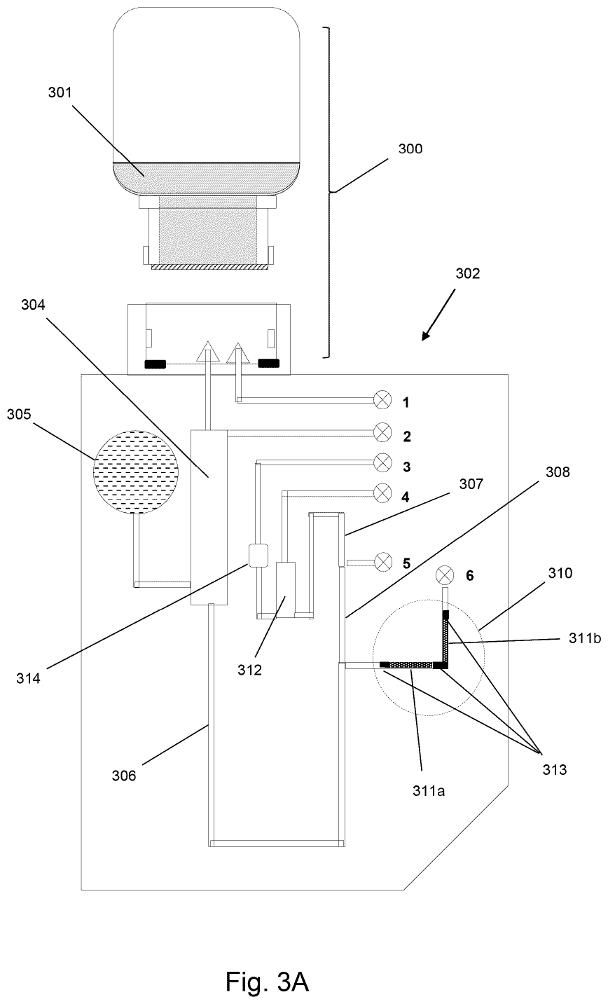

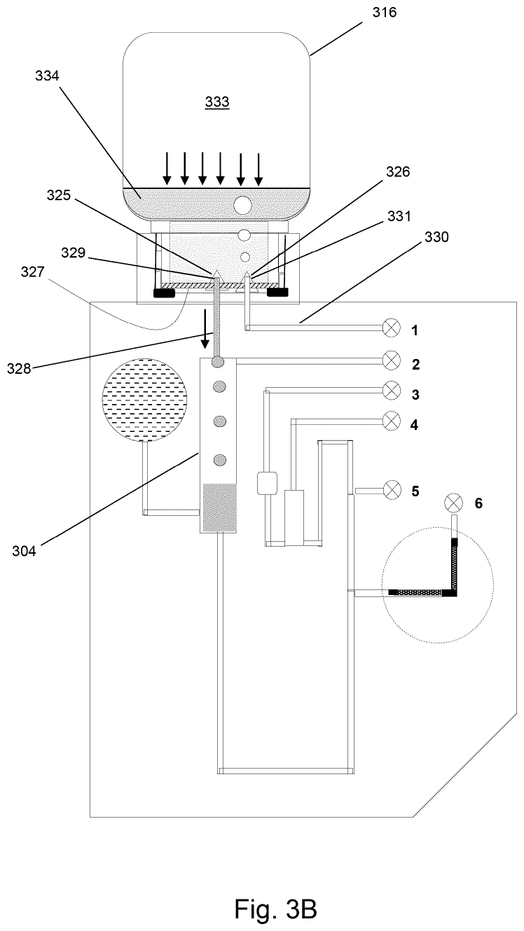

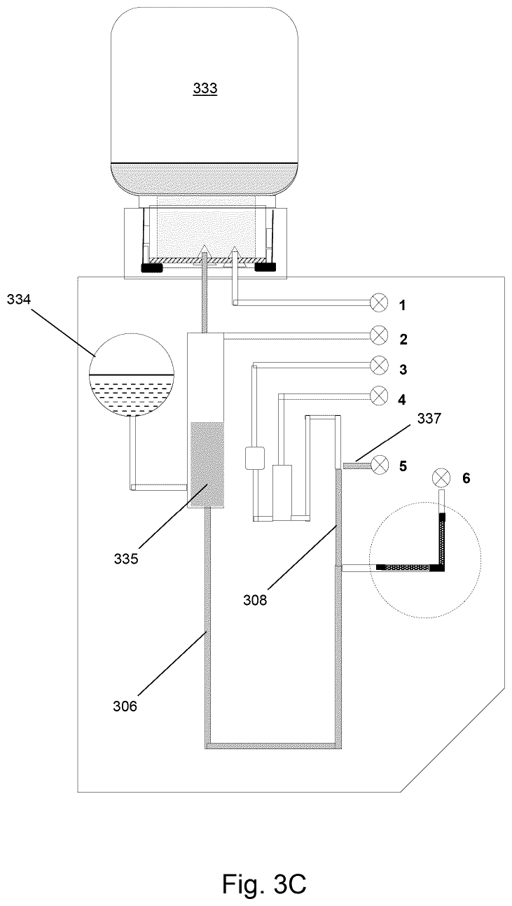

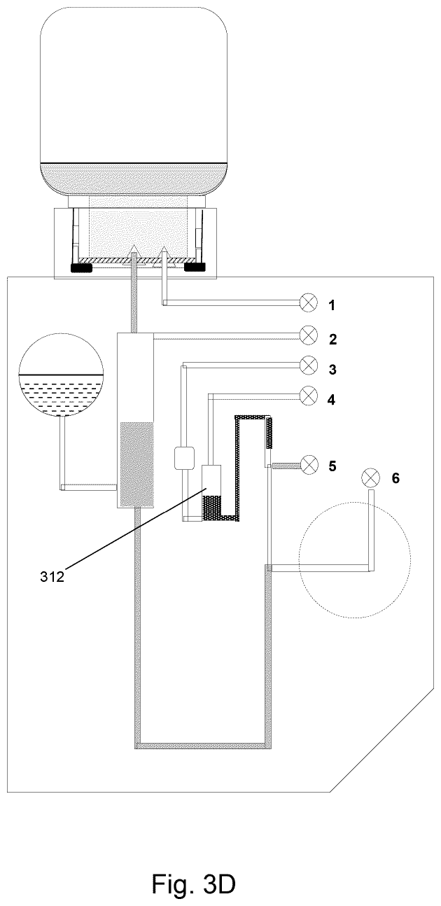

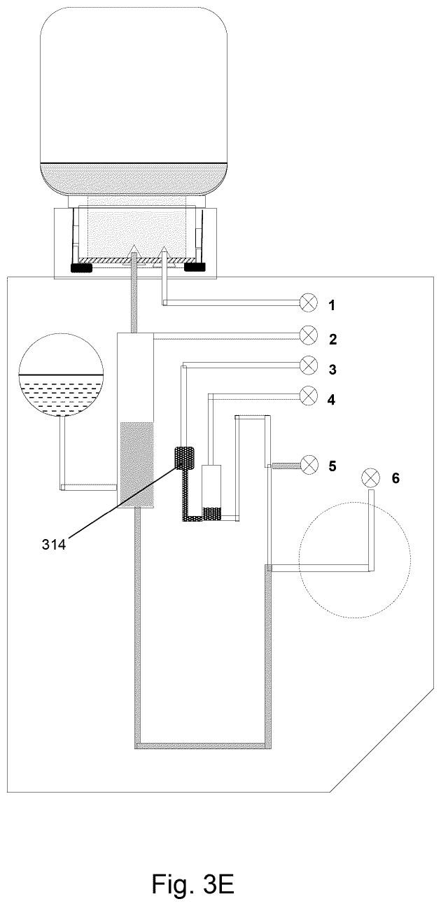

FIGS. 3A-3E illustrates the application of a module of the invention to a specific cartridge for carrying out an isothermal amplification assay for detecting the presence of a target polynucleotide in a patient sample, such as, a sputum or saliva sample. It is understood that the fluid input module could be used with many other microfluidic designs for carrying out many other kinds of assays. As shown in FIG. 3A fluid input module (300) containing sample (301) is as described above. Cartridge (302) comprises the following components in fluid communication as described: sample chamber (304), lysis buffer chamber (305), conduit (306), metering chamber (308), bioassay reagent chamber (310), mixing chamber (312), detection chamber (314), along with vent ports 1-6 that sealingly connect to valves in an appliance, which valves in the open position may provide a vent, pressure source, or vacuum source as described. The appliance also provides heat sources as described.

In general, the microfluidics device of cartridge (302) operates as follows: sample chamber (304) typically has oblong dimensions with a top and a bottom in the same orientation as the top and bottom of the planar body of cartridge (304) (particularly when inserted into and in operational association with an appliance) and has a first inlet at its top for accepting a biological sample, a vent port at its top allowing the passage of air but not liquid, and an outlet at its bottom connected to conduit (306). The vent port is capable of being sealingly connected to a valve in the appliance. Lysis buffer reservoir (305) is optional and contains a predetermined quantity of lysis buffer that is capable of being released through a passage connected to a second inlet of the sample chamber. Lysis buffer reservoir (306) may be configured as a blister pack. Metering chamber (308) has a top and a bottom in the same orientation as the top and bottom of the planar body of cartridge (302) such that the bottom of the metering chamber is (i) connected to reagent chamber (310) and (ii) connected to and in fluid communication with the outlet of the sample chamber through the conduit (306) and such that the top of the metering chamber is (iii) connected to metering vent port (5) and (iv) connected to mixing chamber conduit (307). The metering vent port is capable of being sealingly connected to a valve in the appliance. Reagent chamber (310) contains assay reagents for performing a bioassay and is connected to the bottom of the metering chamber by a passage and connected to reagent vent port (6) allowing the passage of air but not liquid. Reagent vent port (6) is capable of being sealingly connected to a valve and pump in the appliance so that the reagent port is capable of accepting air pressure for forcing the assay reagents into the bottom of metering chamber. Multiple reagents (e.g. primers (311a) and enzymes (311b)) may be contained separately by a wax barriers (e.g. (313)) or a hydrogel barrier, may be used to isolate the bioassay reagents for storage before use. In some embodiments, such as those using dried reagents disposed in the mixing chamber, a reagent chamber may contain only a solvent, e.g. a buffer solution, which may be moved into the mixing chamber to reconstitute dehydrated assay reagent prior to performing an assay. Conduit (306) is a passage connecting the outlet of the sample chamber to the bottom of the metering chamber and is in fluid communication with the passage connecting the reagent chamber to the bottom of the metering chamber, wherein fluid occupying the first conduit has a fluid resistance such that whenever pressure is applied to the reagent chamber from the reagent vent port a flow of reagents from the reagent chamber move substantially only into the metering chamber. Mixing chamber (312) allows for mixing of the lysis buffer-sample mixture with the assay reagent(s). Mixing chamber (312) has a top and a bottom in the same orientation as the top and bottom of the planar body of cartridge (302) and is in fluid communication with the metering chamber by a passage connecting the bottom of the mixing chamber to the top of the metering chamber, so that fluid flowing from the metering chamber fills the mixing chamber from bottom to top. The mixing chamber is also connected at its top to mixing vent port (4) that allows the passage of air but not liquid. Mixing vent port (4) is capable of being sealingly connected to a valve in the appliance. Detection chamber (314) has a top and a bottom in the same orientation as the top and bottom of the planar body of cartridge (302) and is in fluid communication with the mixing chamber by a passage connecting the bottom of the detection chamber to the bottom of the mixing chamber. Detection chamber (314) is also connected at its top to a detection vent port that allows the passage of air but not liquid, wherein the detection vent port is capable of being sealingly connected to a valve and vacuum source in the appliance so that the detection port is capable of accepting a vacuum for drawing the mixture of assay reagents, lysis buffer and sample into the bottom of detection chamber from the mixing chamber.

Once a cartridge is loaded with a sample and operationally inserted into an appliance, a series of steps are implemented for releasing a lysis buffer (and optionally other reagents, such as nuclease inhibitors), incubating the sample in lysis buffer, metering a quantity of lysis buffer containing released biomolecules by re-configuring vent ports to force reagent to flow through the metering chamber to push a metered amount of lysis buffer-sample mixture into the mixing chamber to mix with bioassay reagents to form a reaction mixture; again re-configuring vent port to force the reaction mixture into the detection chamber, after which a bioassay is performed and a signal is detected to indicate a presence or quantity of a biomolecule.

Returning to FIG. 3B, connection of container (316) to cartridge (302) by mating the respective snap-on fittings of the cap and microfluidics inlet causes piercing elements (325 and 326) to pierce pierceable film (327) which places inlet passage (328) and outlet passage (330) in fluid communication with interior (333) of container (316) via inlet port (329) and outlet port (331), respectively. After insertion of cartridge (302) into an appliance (not shown), a valve in the appliance associated vent port (1) is open to allow pressurized gas, e.g. air, to enter interior (333) of container (316) at a predetermined rate, thereby forcing fluid (334) through inlet (329) and into passage (328) and finally into sample chamber (304). After a predetermined time, the valve associated with vent port (1) is closed and the processing steps of the microfluidic device of cartridge (302) commence, for example, as illustrated in FIGS. 3C-3E. Briefly, as shown in FIG. 3C, lysis buffer from lysis buffer chamber (305) is mixed with the fluid in sample chamber (304) (the mixture being referred to herein as the “sample fluid”). The movement of lysis buffer from lysis buffer chamber (305) to sample chamber (304) may be accomplished by breaking a blister pack containing the lysis buffer and letting the liquid flow to sample chamber (304) under gravity. Breaking the blister pack may be accomplished by a mechanical actuator in the associated appliance. After such mixing and possible incubation (including possible heating), vent ports (2) and (5) are opened and vacuum is applied at vent port (5), vent ports (3) and (4) are closed, thereby causing sample fluid (335) to flow through conduit (306) into metering chamber (308) and into passage (337). Next, as illustrated in FIG. 3D, vent port (5) is closed, vent ports (3) and (4) are opened, wax barriers (313 of FIG. 3A) are melted, vent port (6) is opened to a pressure source, which forces bioassay reagents (311a and 311b) and the metered amount of sample fluid into mixing chamber (312). As shown in FIG. 3E, after mixing (to give a bioassay reaction mixture), vacuum is applied to vent port (3) so that a predetermined volume of reaction mixture is transferred to detection chamber (314) where (for example) one or more target polynucleotides are amplified to generate a detectable product which is detected by a detection station in the associated appliance.

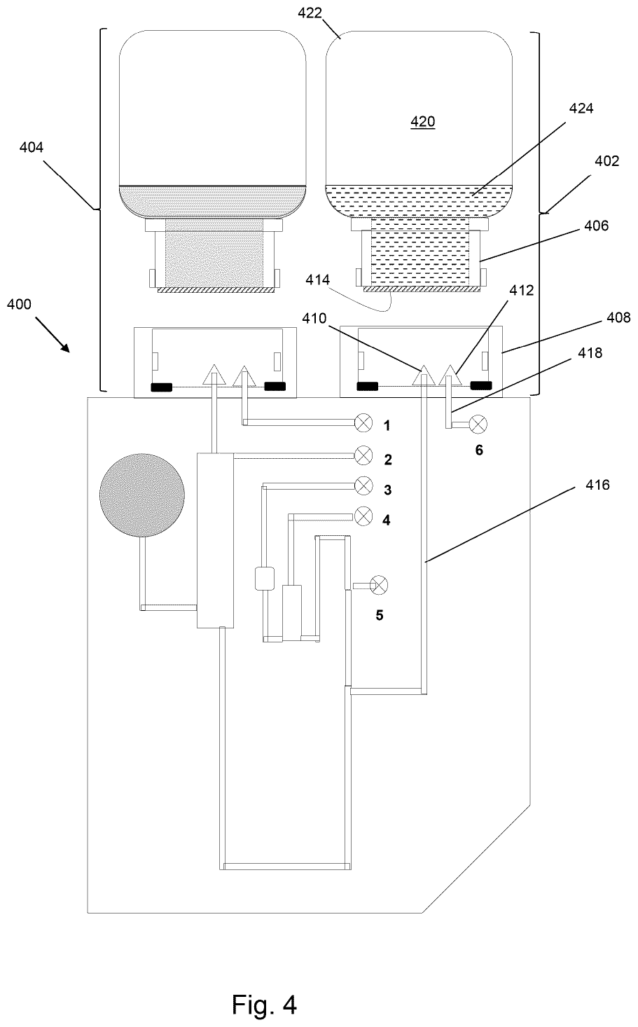

In accordance with the invention, more than one fluid input modules may be introduced into a microfluidics device more than one different fluids, e.g. a sample and an assay reagent, as illustrated in FIG. 4. There a microfluidics cartridge (400) is shown that has a microfluidics circuit identical to that of cartridge (302 of FIG. 3A), except that reagent chamber (310) is replaced with a second fluid input module (402). The second fluid input module (402) operates similarly to sample module (404), as described above. Namely, after snap-on fittings (406 and 408) are engaged, piercing elements (410 and 412) pierce pierceable film (414) to place passages (416 and 418) into fluid communication with interior (420) of container (422). Whenever reagent (424) is required (e.g. after sample fluid is loaded into the metering chamber), vent port (6) is opened to pressurized gas, thereby creating a pressure head in interior (420) which, in turn, pushes reagent (424) into the microfluidics circuit.

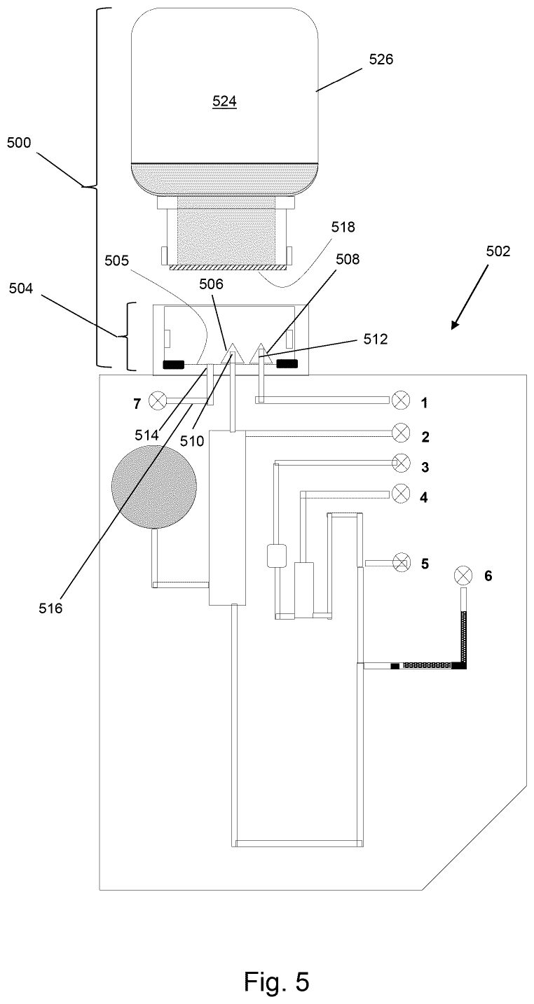

In some embodiments, in addition to an inlet port and an outlet port in the planar region of a microfluidics inlet, a vacuum port is disposed in the planar region which is connectable to a vacuum source. The delivery of a vacuum to the exterior side of the pierceable film after, or coincident with, the engagement of the snap-on fittings provides additional force for pressing the piercing elements against the pierceable film to ensure passages are created in the film. The vacuum delivered by the vacuum port pulls the pierceable film onto the piercing elements and counteracts backing off of the pierceable film caused by its flexibility or elastomeric properties. An exemplary arrangement of a vacuum port in a module of the invention is illustrated in FIG. 5. Module (500) and cartridge (502) are essentially the same as those of FIG. 3A except for microfluidics inlet (504). Planar region (505) of microfluidics inlet (504) comprises piercing elements (506 and 508) with associated inlet port (510) and outlet port (512), respectively, and vacuum port (514) connected by passage (516) to vent port (7) which, in turn, is sealingly connected to a valve in an associated appliance which can be controlled to provide vacuum at vacuum port (514). Whenever pierceable film (518) is forced against planar region (505) by connecting snap-on fittings (520 and 522) and applying vacuum through vacuum port (514), piercing elements puncture pierceable film (518) to put interior (524) of container (526) in fluid communication with the microfluidics circuit of cartridge (502) through inlet port (510) and outlet port (512).

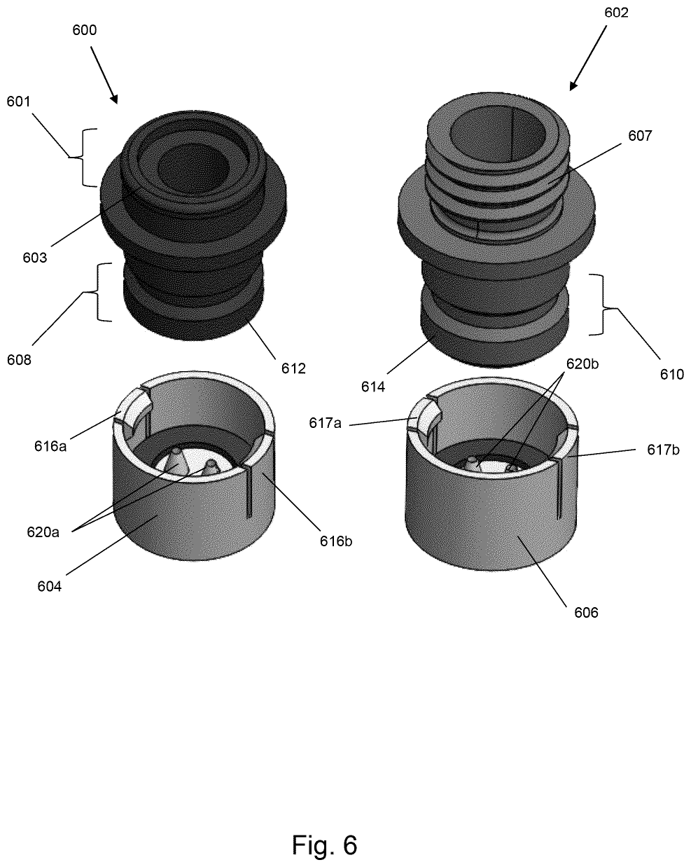

FIG. 6 illustrates alternative caps (600 and 602) that connect to a container (e.g. 202 of FIG. 2A) by means of a snap-on connection (600) or a screw-on connection (602). Snap-on connector (601) comprises outward facing annular collar (603) for connecting to a complementary female snap-on fitting of a container, whereas cap 602) has a screw-on fitting (607) for connecting to a complementary screw-on fitting of a container. Also illustrated are microfluidics inlets (604 and 606) comprising female snap-on fittings into which male snap-on fittings (608 and 610) are inserted for establishing a connection. In these examples, outward facing annular collars (612 and 614) are axially forced past retaining elements (616a and 616b and 617a and 617b) which hook or clip onto outward facing annular collars (612 and 614, respectively) thereby (i) forming a secure connection, (ii) an air tight seal between caps (600 and 602) and their respective microfluidics inlets (604 and 606), and (iii) forcing piercing elements (620a and 620b) in contact with the pierceable film (not shown) to create openings in the pierceable film and fluid communication between the microfluidics circuits associated with microfluidics inlets (604 and 606) and the containers associated with caps (600 and 602).

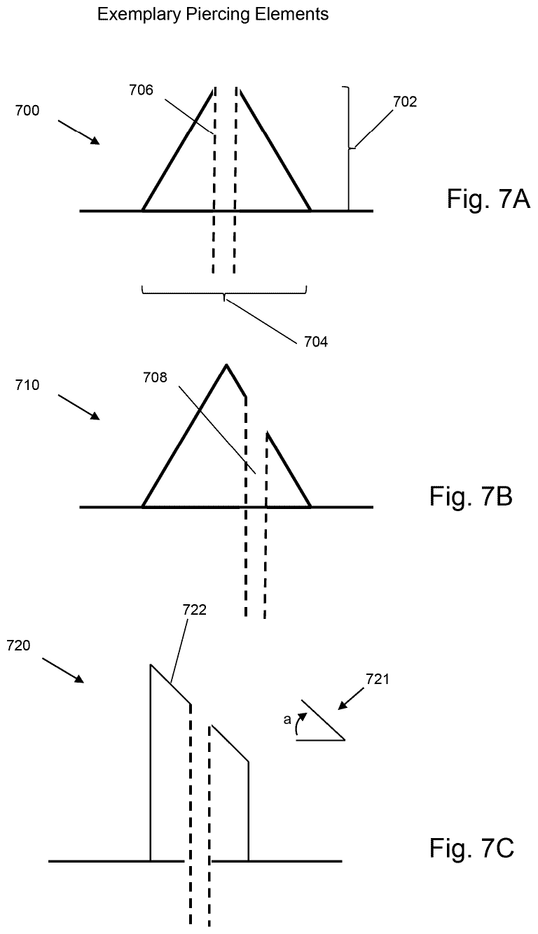

As mentioned above, piercing elements of the invention may have a variety of shapes and sizes consistent with their function of piercing a pierceable film and establishing effective fluid communication between a container and the respective inlet port and outlet port. Generally piercing elements have a pointed shape suitable for puncturing and penetrating the pierceable film. Another feature of piercing elements is the material from which such elements and the microfluidics inlet are constructed. In some embodiments, such components are molded plastic, which places practical limitations on size, shape and complexity of the structures. FIGS. 7A-7C illustrates shapes of exemplary piercing elements. FIG. 7A illustrates a cross section of conically or pyramidally shaped piercing element (700) with central passage (706) oriented coaxially with piercing element (700). In embodiments composed of plastic and fabricated by molding, ratios of height (702) to width (704) may be in the range of from 10:1 to 1:1 with heights in the range of from 1 to 3 mm and passage (706) having a diameter down to 300 μm (i.e. having a diameter of at least 300 μm). As illustrated in FIG. 7B, the longitudinal axis of passage (708) may be offset from the axis of piercing element (710). As illustrated in FIG. 7C, in some embodiments, piercing element (720) may be cylindrical with beveled end (722) to provide a puncturing edge, similar to that of a hypodermic needle. In some embodiments of FIG. 7C, bevel angle “a” (721) may vary between 45 degrees and 60 degrees. In some embodiments, piercing elements are spaced apart from each other, for example, to avoid possible interruption of fluid input, unnecessary dispersal of fluid between the planar region and the pierceable film, and the like. In some embodiments, pierceable element are spaced from 1-10 mm apart. In some embodiments, piercing elements are spaced away from the edge of the planar region by a distance in the range of from 1-10 mm.

### Manufacture of Cartridges and Appliances

Body of cartridge (201, FIG. 2A) may comprise, and the elements described above, such as, chambers and passages, may be formed in, a wide variety of materials well-known in the microfluidics field, such as, silicon, glass, plastic, or the like, e.g. Ren et al, Acc. Chem. Res., 46 (11): 2396-2406 (2013). That is, devices of the invention may be fabricated as microfluidics devices using well-known techniques and methodologies of the microfluidic field. In some embodiments, body of cartridge (201) comprises a plastic, such as, polystyrene, polyethylenetetraphthalate glycol, polyethylene terephthalate, polymethylmethacrylate, polyvinylchloride, polycarbonate, thermo plastic elastomer or the like. Modules and devices of the invention may be fabricated with or in plastic using well-known techniques including, but not limited to, hot embossing, injection molding, laser cutting, milling, etching, 3D printing, or the like. Guidance in the selection of plastics and fabrication methodologies may be found in the following references: Becker et al, Talanta, 56:267-287 (2002); Fiorini et al, Biotechniques, 38 (3): 429-446 (2005); Bjornson et al. U.S. Pat. No. 6,803,019; Soane et al, U.S. Pat. No. 6,176,962; Schaevitz et al, U.S. Pat. No. 6,908,594; Neyer et al, U.S. Pat. No. 6,838,156; and the like, which references are incorporated herein by reference. Appliances for use with cartridges of the invention may be constructed using conventional engineering design principles and materials, e.g. as described in Moore (cited above).

### Bioassays

A wide variety of bioassays may be performed in cartridges designed and manufactured in accordance with the invention. Bioassays may include assays based on nucleic acid amplification, such as, polymerase chain reactions (PCRs), immunoassays, and the like. In some embodiments, bioassays implemented with the invention are nucleic acid assays, and particularly nucleic acid assays that employ isothermal amplification of one or more target polynucleotides. Isothermal amplification is advantageous because the added components required for thermal cycling, possibly in a separate chamber, is avoided. Many isothermal amplification techniques may be used with the invention including, but not limited to, Nucleic acid sequence-based amplification (NASBA), transcription mediated amplification (TMA), self-sustained sequence replication (3SR), signal-mediated amplification of RNA technology (SMART), strand displacement amplification (SDA), rolling circle amplification (RCA), loop-mediated isothermal amplification of DNA (LAMP), isothermal multiple displacement amplification (TMDA), helicase dependent amplification (HDA), single primer isothermal amplification (SPIA), circular helicase-dependent amplification (cHDA), recombinase-polymerase amplification (RPA), CRISPR-based nucleic acid detection, and the like, e.g. Karami et al, J. Global Infect. Dis., 3 (3): 293-302 (2011); Gill et al, Nucleosides, Nucleotides & Nucleic Acids, 27:224-243 (2008); Wang et al, U.S. Pat. No. 8,673,567; Notomi et al, Nucleic Acids Research, 28 (12): e63 (2000); Notomi et al, U.S. Pat. No. 6,410,278; Burns et al, U.S. Pat. No. 6,379,929; Pack et al, U.S. patent publication 2008/0182312; Armes et al, U.S. Pat. No. 7,485,428; Agrawal et al, medRxiv, https://doi.org/10.1101/2020.12.14.20247874 (published Apr. 4, 2021); which references are incorporated by reference. In one embodiment, cartridges of the invention perform a LAMP isothermal amplification. In such embodiments, one or more reagent chambers comprise a DNA polymerase, a primer set for a target polynucleotide, and deoxynucleoside triphosphates (dNTPs). In a further embodiment for detecting RNA target biomolecules, the one or more reagent chambers further contain a reverse transcriptase. In some embodiments, a LAMP amplification product is detected optically. In some embodiments, such optical detection is based on an optical measure of the turbidity of the LAMP amplification mixture, e.g. magnitude of light transmission, magnitude of light scatter, or the like, Zhu et al, ACS Omega, 5:5421-5428 (2020). In other embodiments, a LAMP amplification product is detected colorimetrically, e.g. Goto et al, Biotechniques, 46 (3): 167-172 (2009). In still other embodiments, a LAMP amplification product is measured by fluorescence, e.g. Gadkar et al, Scientific Reports, 8:5548 (2018); Hardinge et al, Scientific Reports, 9:7400 (2019); or the like, wherein fluorescence intensity may be monotonically related to amount of target polynucleotide in a sample. In some embodiments, an intercalating fluorescent DNA dye is used to measure the quantity of LAMP amplification product, e.g. Oscorbin et al, Biotechniques, 61 (1): 20-25 (2016); Quyen et al, Frontiers Microbiol., 10:2234 (2019); or the like.

### Samples and Lysis Buffers

Cartridges and appliances of the invention may be adapted to detect and measure biomolecules in a wide variety of biological samples. Typically a lysis buffer or lysis condition is selected to facilitate access of the biomolecules of interest in a sample to reagents of a bioassay. Lysis may be accomplished or facilitated mechanically, chemically, electrically or thermally. Determining the best lysis buffer for a particular sample type and biomolecule can be accomplished by those of ordinary skill, for example, as exemplified by the following references: Kim et al, Integrative Biology, 1:574-586 (2009); Svec et al, Frontiers in Oncology, 3:1-11 (2013); E. H. Lennette (ed.), Laboratory Diagnosis of Viral Infections, second edition (Marcel Dekker, Inc., New York, 1992); Fiechtner et al, U.S. Pat. No. 10,520,498; which are hereby incorporated by reference. In some embodiments, a reaction mixture for a bioassay may comprise a lysis buffer to facilitate access of the assay reagents to target nucleic acids. Lysing conditions may vary widely and may be based on the action of heat, detergent, protease, alkaline, chaotropic agents or combinations of such factors. Whenever biomolecules of interest are viral polynucleotides in a sample comprising viral particles shed into a biological fluid, e.g. saliva, in some embodiments, a lysis buffer may comprise agents to disrupt the viral protein coat and to protect the release nucleic acids, such as RNA. In some embodiments, a lysis buffer may comprise a chaotropic agent, a detergent and a nuclease inhibitor. Exemplary chaotropic agents include guanidinium thiocyanate and guanidinium chloride. Exemplary lysis buffers for use with RNA viruses may be obtained commercially, e.g. Qiagen ATL (25-50% Guanidinium Thiocyanate (GITC) and 1-10% sodium dodecyl sulfate), VXL (25-50% GITC, 2.5-10% Triton-X-100), and AVL (50-70% GITC).

While the present invention has been described with reference to several particular example embodiments, those skilled in the art will recognize that many changes may be made thereto without departing from the spirit and scope of the present invention. The present invention is applicable to a variety of implementations in addition to those discussed above.

### Definitions

“Amplicon” means the product of a polynucleotide amplification reaction; that is, a clonal population of polynucleotides, which may be single stranded or double stranded, which are replicated from one or more starting sequences. “Amplifying” means producing an amplicon by carrying out an amplification reaction. The one or more starting sequences may be one or more copies of the same sequence, or they may be a mixture of different sequences. Preferably, amplicons are formed by the amplification of a single starting sequence. Amplicons may be produced by a variety of amplification reactions whose products comprise replicates of the one or more starting, or target, nucleic acids. In one aspect, amplification reactions producing amplicons are “template-driven” in that base pairing of reactants, either nucleotides or oligonucleotides, have complements in a template polynucleotide that are required for the creation of reaction products. In one aspect, template-driven reactions are primer extensions with a nucleic acid polymerase or oligonucleotide ligations with a nucleic acid ligase. Such reactions include, but are not limited to, polymerase chain reactions (PCRs), linear polymerase reactions, nucleic acid sequence-based amplification (NASBAs), rolling circle amplifications, and the like, disclosed in the following references that are incorporated herein by reference: Mullis et al, U.S. patents 4,683, 195; 4,965,188; 4,683,202; 4,800,159 (PCR); Gelfand et al, U.S. Pat. No. 5,210,015 (real-time PCR with “taqman” probes); Wittwer et al, U.S. Pat. No. 6,174,670; Kacian et al, U.S. Pat. No. 5,399,491 (“NASBA”); Lizardi, U.S. Pat. No. 5,854,033; Aono et al, Japanese patent publ. JP 4-262799 (rolling circle amplification); and the like. In one aspect, amplicons of the invention are produced by PCRs. An amplification reaction may be a “real-time” amplification if a detection chemistry is available that permits a reaction product to be measured as the amplification reaction progresses, e.g. “real-time PCR” described below, or “real-time NASBA” as described in Leone et al, Nucleic Acids Research, 26:2150-2155 (1998), and like references. As used herein, the term “amplifying” means performing an amplification reaction. A “reaction mixture” means a solution containing all the necessary reactants for performing a reaction, which may include, but not be limited to, buffering agents to maintain pH at a selected level during a reaction, salts, co-factors, scavengers, and the like.

“Bioassay” or “assay” means any assay to detect or measure the quantity of a biomolecule. Exemplary biomolecules that may be detected or measured include deoxyribonucleic acids (DNAs), ribonucleic acids (RNAs), proteins, peptides, polysaccharides, lipids, and the like. Further exemplary biomolecules include genes, gene fragments, messenger RNAs (mRNAs), hormones, vitamins, enzymes, coenzymes, immunoglobulins, and the like, e.g. Lehninger, Biochemistry, 2nd Edition (Worth Publishers, 1971). In some embodiments, a bioassay is an assay to detect or measure the quantity of a polynucleotide. In some embodiments, a bioassay comprises a polynucleotide amplification. In some embodiments, a bioassay comprises separate polynucleotide amplification and detection steps.

“Bioassay reagents” or “assay reagents,” or “reagents,” which are used interchangeably herein, mean reagents used to perform an analytical reaction or bioassay on a cartridge containing or comprising a microfluidics device. Such reagents may include enzymes, enzyme co-factors, primers, waxes (e.g. for bubble suppression), salts, buffers, solvents, agents to modify the secondary structure of analytes, labels (such as fluorescent dyes or fluorescently labeled oligonucleotides), lysis buffers, and the like, which make up components of a reaction mixture. In some embodiments, assay reagents include reagents for carrying out an isothermal amplification of one or more target polynucleotides.

“Dried reagents” mean assay reagents, such as buffers, salts, active compounds, such as enzymes, co-factors, and the like, or binding compounds, such as antibodies, aptamers, or the like, that are provided in a dehydrated formulation for the purpose of improved shelf-life, case of transport and handling, improved storage, and the like. The nature, composition, and method of producing dried reagents vary widely and the formulation and production of such materials is well-known to those of ordinary skill in the art as evidenced by the following references that are incorporated by reference: Franks et al, U.S. Pat. No. 5,098,893; Cole, U.S. Pat. No. 5,102,788; Shen et al, U.S. Pat. No. 5,556,771; Treml et al, U.S. Pat. No. 5,763,157; De Rosier et al, U.S. Pat. No. 6,294,365; Buhl et al, U.S. Pat. No. 5,413,732; McMillan, U.S. patent publication 2006/0068398; McMillan et al, U.S. patent publication 2006/0068399; Schwegman et la (2005), Pharm. Dev. Technol., 10:151-173; Nail et al (2002), Pharm. Biotechnol., 14:281-360; and the like. Dried reagents include, but are not limited to, solid and/or semi-solid particulates, powders, tablets, crystals, capsules and the like, that are manufactured in a variety of ways. In one aspect, dried reagents are lyophilized particulates. Lyophilized particulates may have uniform compositions, wherein each particulate has the same composition, or they may have different compositions, such that two or more different kinds of lyophilized particulates having different compositions are mixed together. Lyophilized particulates can contain reagents for all or part of a wide variety of assays and biochemical reactions, including immunoassays, enzyme-based assays, enzyme substrate assays, and the like. In one aspect, a lyophilized particulate of the invention comprises an excipient and at least one reagent of an assay. Lyophilized particulates may be manufactured in predetermined sizes and shapes, which may be determined by the type of assay being conducted, desired reaction volume, desired speed of dissolution, and the like. In some embodiments, lyophilized particulates are provided in a size such that they are mobile within whatever chamber they are disposed in. Dried reagents may include excipients, which are usually inert substances added to a material in order to confer a suitable consistency or form to the material. A large number of excipients are known to those of skill in the art and can comprise a number of different chemical structures. Examples of excipients, which may be used in the present invention, include carbohydrates, such as sucrose, glucose, trehalose, melezitose, dextran, and mannitol; proteins such as BSA, gelatin, and collagen; and polymers such as PEG and polyvinyl pyrrolidone (PVP). The total amount of excipient in the lyophilized particulate may comprise either single or multiple compounds. In some embodiments, the type of excipient is a factor in controlling the amount of hygroscopy of a dried reagent. Lowering hygroscopy can enhance the a dried reagent's integrity and cryoprotectant abilities. However, removing all water from such a composition would have deleterious effects on those reaction components, proteins for example, that require certain amounts of bound water in order to maintain proper conformations.

“Isothermal amplification” in reference to an assay to detect or quantify a target nucleic acid or polynucleotide means a method of replicating a target nucleic acid without a requirement of thermal cycling. That is, without a requirement of subjecting a reaction mixture to cycles of different temperatures in order to melt target nucleic acid strands, anneal primers and provide for extension conditions for a DNA polymerase. An isothermal amplification is typically performed at a predetermined temperature.

“Microfluidics” device or “nanofluidics” device, used interchangeably herein, each means an integrated system for capturing, moving, mixing, dispensing or analyzing small volumes of fluid, including samples (which, in turn, may contain or comprise cellular or molecular analytes of interest), reagents, dilutants, buffers, or the like. Generally, reference to “microfluidics” and “nanofluidics” denotes different scales in the size of devices and volumes of fluids handled. In some embodiments, features of a microfluidic device have cross-sectional dimensions of less than a few hundred square micrometers and have passages, or channels, with capillary dimensions, e.g. having maximal cross-sectional dimensions of from about 1-2 mm to about 0.1 μm. In some embodiments, microfluidics devices have volume capacities in the range of from 100 μL to a few nL, e.g. 10-100 nL or in the range of from 100 μL to 1 μL. Dimensions of corresponding features, or structures, in nanofluidics devices are typically from 1 to 3 orders of magnitude less than those for microfluidics devices. One skilled in the art would know from the circumstances of a particular application which dimensionality would be pertinent. In some embodiments, microfluidic or nanofluidic devices have one or more chambers, ports, and channels that are interconnected and in fluid communication and that are designed for carrying out one or more analytical reactions or processes, either alone or in cooperation with an appliance or instrument that provides support functions, such as sample introduction, fluid and/or reagent driving means, such as positive or negative pressure, acoustical energy, or the like, temperature control, detection systems, data collection and/or integration systems, and the like. Such networks of interconnected chambers, ports, channels and the like are sometimes referred to herein as a “microfluidics circuit” or a “nanofluidics circuit.” In some embodiments, microfluidics and nanofluidics devices may further include valves, pumps, filters and specialized functional coatings on interior walls, e.g. to prevent adsorption of sample components or reactants, facilitate reagent movement by electroosmosis, or the like. Such devices may be fabricated as an integrated device in a solid substrate, which may be glass, plastic, or other solid polymeric materials, and may have a planar format for ease of detecting and monitoring sample and reagent movement, especially via optical or electrochemical methods. In some embodiments, such devices are disposable after a single use. In some embodiments, microfluidic and nanofluidic devices include devices that form and control the movement, mixing, dispensing and analysis of droplets, such as, aqueous droplets immersed in an immiscible fluid, such as a light oil. The fabrication and operation of microfluidics and nanofluidics devices are well-known in the art as exemplified by the following references that are incorporated by reference: Ramsey, U.S. Pat. Nos. 6,001,229; 5,858,195; 6,010,607; and 6,033,546; Soane et al, U.S. Pat. Nos. 5,126,022 and 6,054,034; Nelson et al, U.S. Pat. No. 6,613,525; Maher et al, U.S. Pat. No. 6,399,952; Ricco et al, International patent publication WO 02/24322; Bjornson et al, International patent publication WO 99/19717; Wilding et al, U.S. Pat. Nos. 5,587,128; 5,498,392; Sia et al, Electrophoresis, 24:3563-3576 (2003); Unger et al, Science, 288:113-116 (2000); Enzelberger et al, U.S. Pat. No. 6,960,437; Cao, “Nanostructures & Nanomaterials: Synthesis, Properties & Applications,” (Imperial College Press, London, 2004); Haeberle et al, LabChip, 7:1094-1110 (2007); Cheng et al, Biochip Technology (CRC Press, 2001); and the like.

“NASBA” or “Nucleic acid sequence-based amplification” is an amplification reaction based on the simultaneous activity of a reverse transcriptase (usually avian myeloblastosis virus (AMV) reverse transcriptase), an RNase H, and an RNA polymerase (usually T7 RNA polymerase) that uses two oligonucleotide primers, and which under conventional conditions can amplify a target sequence by a factor in the range of 109 to 1012 in 90 to 120 minutes. In a NASBA reaction, nucleic acids are a template for the amplification reaction only if they are single stranded and contain a primer binding site. Because NASBA is isothermal (usually carried out at 41° C. with the above enzymes), specific amplification of single stranded RNA may be accomplished if denaturation of double stranded DNA is prevented in the sample preparation procedure. That is, it is possible to detect a single stranded RNA target in a double stranded DNA background without getting false positive results caused by complex genomic DNA, in contrast with other techniques, such as RT-PCR. By using fluorescent indicators compatible with the reaction, such as molecular beacons, NASBAs may be carried out with real-time detection of the amplicon. Molecular beacons are stem-and-loop-structured oligonucleotides with a fluorescent label at one end and a quencher at the other end, e.g. 5′-fluorescein and 3′-(4-(dimethylamino)phenyl) azo) benzoic acid (i.e., 3′-DABCYL), as disclosed by Tyagi and Kramer (cited above). An exemplary molecular beacon may have complementary stem strands of six nucleotides, e.g. 4 G's or C's and 2 A's or T's, and a target-specific loop of about 20 nucleotides, so that the molecular beacon can form a stable hybrid with a target sequence at reaction temperature, e.g. 41° C. A typical NASBA reaction mix is 80 mM Tris-HCl [pH 8.5], 24 mM MgCl2, 140 mM KCl, 1.0 mM DTT, 2.0 mM of each dNTP, 4.0 mM each of ATP, UTP and CTP, 3.0 mM GTP, and 1.0 mM ITP in 30% DMSO. Primer concentration is 0.1 μM and molecular beacon concentration is 40 nM. Enzyme mix is 375 sorbitol, 2.1 μg BSA, 0.08 U RNase H, 32 U T7 RNA polymerase, and 6.4 U AMV reverse transcriptase. A reaction may comprise 5 μL sample, 10 μL NASBA reaction mix, and 5 μL enzyme mix, for a total reaction volume of 20 μL. Further guidance for carrying out real-time NASBA reactions is disclosed in the following references that are incorporated by reference: Polstra et al, BMC Infectious Diseases, 2:18 (2002); Leone et al, Nucleic Acids Research, 26:2150-2155 (1998); Gulliksen et al, Anal. Chem., 76:9-14 (2004); Weusten et al, Nucleic Acids Research, 30 (6) e26 (2002); Deiman et al, Mol. Biotechnol., 20:163-179 (2002). Nested NASBA reactions are carried out similarly to nested PCRs; namely, the amplicon of a first NASBA reaction becomes the sample for a second NASBA reaction using a new set of primers, at least one of which binds to an interior location of the first amplicon.

“Polynucleotide” or “oligonucleotide” are used interchangeably and each mean a linear polymer of nucleotide monomers or analogs thereof. Monomers making up polynucleotides and oligonucleotides are capable of specifically binding to a natural polynucleotide by way of a regular pattern of monomer-to-monomer interactions, such as Watson-Crick type of base pairing, base stacking, Hoogsteen or reverse Hoogsteen types of base pairing, or the like. Such monomers and their internucleosidic linkages may be naturally occurring or may be analogs thereof, e.g. naturally occurring or non-naturally occurring analogs. Non-naturally occurring analogs may include PNAs, phosphorothioate internucleosidic linkages, bases containing linking groups permitting the attachment of labels, such as fluorophores, or haptens, and the like. Whenever the use of an oligonucleotide or polynucleotide requires enzymatic processing, such as extension by a polymerase, ligation by a ligase, or the like, one of ordinary skill would understand that oligonucleotides or polynucleotides in those instances would not contain certain analogs of internucleosidic linkages, sugar moieties, or bases at any or some positions. Polynucleotides typically range in size from a few monomeric units, e.g. 5-40, when they are usually referred to as “oligonucleotides,” to several thousand monomeric units. Whenever a polynucleotide or oligonucleotide is represented by a sequence of letters (upper or lower case), such as “ATGCCTG,” it will be understood that the nucleotides are in 5′→3′ order from left to right and that “A” denotes deoxyadenosine, “C” denotes deoxycytidine, “G” denotes deoxyguanosine, and “T” denotes thymidine, “I” denotes deoxyinosine, “U” denotes uridine, unless otherwise indicated or obvious from context. Unless otherwise noted the terminology and atom numbering conventions will follow those disclosed in Strachan and Read, Human Molecular Genetics 2 (Wiley-Liss, New York, 1999). Usually polynucleotides comprise the four natural nucleosides (e.g. deoxyadenosine, deoxycytidine, deoxyguanosine, deoxythymidine for DNA or their ribose counterparts for RNA) linked by phosphodiester linkages; however, they may also comprise non-natural nucleotide analogs, e.g. including modified bases, sugars, or internucleosidic linkages. It is clear to those skilled in the art that where an enzyme has specific oligonucleotide or polynucleotide substrate requirements for activity, e.g. single stranded DNA, RNA/DNA duplex, or the like, then selection of appropriate composition for the oligonucleotide or polynucleotide substrates is well within the knowledge of one of ordinary skill, especially with guidance from treatises, such as Sambrook et al, Molecular Cloning, Second Edition (Cold Spring Harbor Laboratory, New York, 1989), and like references. Likewise, the oligonucleotide and polynucleotide may refer to either a single stranded form or a double stranded form (i.e. duplexes of an oligonucleotide or polynucleotide and its respective complement). It will be clear to one of ordinary skill which form or whether both forms are intended from the context of the terms usage.

“Primer” means an oligonucleotide, either natural or synthetic that is capable, upon forming a duplex with a polynucleotide template, of acting as a point of initiation of nucleic acid synthesis and being extended from its 3′ end along the template so that an extended duplex is formed. Extension of a primer is usually carried out with a nucleic acid polymerase, such as a DNA or RNA polymerase. The sequence of nucleotides added in the extension process is determined by the sequence of the template polynucleotide. Usually primers are extended by a DNA polymerase. Primers usually have a length in the range of from 14 to 40 nucleotides, or in the range of from 18 to 36 nucleotides. Primers are employed in a variety of nucleic amplification reactions, for example, linear amplification reactions using a single primer, or polymerase chain reactions, employing two or more primers. Guidance for selecting the lengths and sequences of primers for particular applications is well known to those of ordinary skill in the art, as evidenced by the following references that are incorporated by reference: Dieffenbach, editor, PCR Primer: A Laboratory Manual, 2nd Edition (Cold Spring Harbor Press, New York, 2003).

“Polymerase chain reaction,” or “PCR,” means a reaction for the in vitro amplification of specific DNA sequences by the simultaneous primer extension of complementary strands of DNA. In other words, PCR is a reaction for making multiple copies or replicates of a target nucleic acid flanked by primer binding sites, such reaction comprising one or more repetitions of the following steps: (i) denaturing the target nucleic acid, (ii) annealing primers to the primer binding sites, and (iii) extending the primers by a nucleic acid polymerase in the presence of nucleoside triphosphates. Usually, the reaction is cycled through different temperatures optimized for each step in a thermal cycler instrument. Particular temperatures, durations at each step, and rates of change between steps depend on many factors well-known to those of ordinary skill in the art, e.g. exemplified by the references: McPherson et al, editors, PCR: A Practical Approach and PCR2: A Practical Approach (IRL Press, Oxford, 1991 and 1995, respectively). For example, in a conventional PCR using Taq DNA polymerase, a double stranded target nucleic acid may be denatured at a temperature >90° C., primers annealed at a temperature in the range 50-75° C., and primers extended at a temperature in the range 72-78° C. The term “PCR” encompasses derivative forms of the reaction, including but not limited to, RT-PCR, real-time PCR, nested PCR, quantitative PCR, multiplexed PCR, and the like. Reaction volumes range from a few hundred nanoliters, e.g. 200 nL, to a few hundred μL, e.g. 200 μL. “Reverse transcription PCR,” or “RT-PCR,” means a PCR that is preceded by a reverse transcription reaction that converts a target RNA to a complementary single stranded DNA, which is then amplified, e.g. Tecott et al, U.S. Pat. No. 5,168,038, which patent is incorporated herein by reference. “Real-time PCR” means a PCR for which the amount of reaction product, i.e. amplicon, is monitored as the reaction proceeds. There are many forms of real-time PCR that differ mainly in the detection chemistries used for monitoring the reaction product, e.g. Gelfand et al, U.S. Pat. No. 5,210,015 (“taqman”); Wittwer et al, U.S. Pat. Nos. 6,174,670 and 6,569,627 (intercalating dyes); Tyagi et al, U.S. Pat. No. 5,925,517 (molecular beacons); which patents are incorporated herein by reference. Detection chemistries for real-time PCR are reviewed in Mackay et al, Nucleic Acids Research, 30:1292-1305 (2002), which is also incorporated herein by reference. “Nested PCR” means a two-stage PCR wherein the amplicon of a first PCR becomes the sample for a second PCR using a new set of primers, at least one of which binds to an interior location of the first amplicon. As used herein, “initial primers” in reference to a nested amplification reaction mean the primers used to generate a first amplicon, and “secondary primers” mean the one or more primers used to generate a second, or nested, amplicon. “Multiplexed PCR” means a PCR wherein multiple target sequences (or a single target sequence and one or more reference sequences) are simultaneously carried out in the same reaction mixture, e.g. Bernard et al, Anal. Biochem., 273:221-228 (1999) (two-color real-time PCR). Usually, distinct sets of primers are employed for each sequence being amplified. “Quantitative PCR” means a PCR designed to measure the abundance of one or more specific target sequences in a sample or specimen. Quantitative PCR includes both absolute quantitation and relative quantitation of such target sequences. Quantitative measurements are made using one or more reference sequences that may be assayed separately or together with a target sequence. The reference sequence may be endogenous or exogenous to a sample or specimen, and in the latter case, may comprise one or more competitor templates. Typical endogenous reference sequences include segments of transcripts of the following genes: β-actin, GAPDH, β₂-microglobulin, ribosomal RNA, and the like. Techniques for quantitative PCR are well-known to those of ordinary skill in the art, as exemplified in the following references that are incorporated by reference: Freeman et al, Biotechniques, 26:112-126 (1999); Becker-Andre et al, Nucleic Acids Research, 17:9437-9447 (1989); Zimmerman et al, Biotechniques, 21:268-279 (1996); Diviacco et al, Gene, 122:3013-3020 (1992); Becker-Andre et al, Nucleic Acids Research, 17:9437-9446 (1989); and the like.

“Readout” means a parameter, or parameters, which are measured and/or detected that can be converted to a number or value. In some contexts, readout may refer to an actual numerical representation of such collected or recorded data. For example, a readout of fluorescent intensity signals from a microarray is the address and fluorescence intensity of a signal being generated at each hybridization site of the microarray; thus, such a readout may be registered or stored in various ways, for example, as an image of the microarray, as a table of numbers, or the like.

“Sample” (or “biological sample” which is sometimes used synonymously) means a quantity of material from a biological, environmental, medical, or patient source in which detection or measurement of target molecule, such as a biomolecule, or such as a target nucleic acids, is sought. On the one hand it is meant to include a specimen or culture (e.g., microbiological cultures). On the other hand, it is meant to include both biological and environmental samples. A sample may include a specimen of synthetic origin. Biological samples may be animal, including human, fluid, solid (e.g., stool) or tissue, such as, fluids from nasal or other schwabs, as well as liquid and solid food and feed products and ingredients such as dairy items, vegetables, meat and meat by-products, and waste. Biological samples may include materials taken from a patient including, but not limited to cultures, blood, saliva, tears, sweat, urine, cerebral spinal fluid, pleural fluid, milk, lymph, sputum, semen, needle aspirates, and the like. Environmental samples include environmental material such as surface matter, soil, water and industrial samples, as well as samples obtained from food and dairy processing instruments, apparatus, equipment, utensils, disposable and non-disposable items. These examples are not to be construed as limiting the sample types applicable to the present invention.

1. A fluid input module for microfluidic cartridges, the module comprising:
a container for holding a fluid, the container comprising an interior and at least one inlet thereto;
a cap comprising a tubular body with an axial passage wherein (i) a first end of the axial passage sealingly connects to an inlet of the container, (ii) a pierceable film sealingly covers a second end of the axial passage, and (iii) the second end of the axial passage comprises a cap fitting; and
an inlet operationally associated with a microfluidic device comprising an inlet fitting capable of forming an air tight seal with the cap fitting, the inlet having a planar region comprising at least one inlet port for accepting fluid from the container and at least one outlet port for inserting a driving fluid into the container to force fluid to exit the container through a predetermined inlet port, wherein the inlet and outlet ports are spaced apart within the planar region and each comprises a piercing element, wherein each piercing element has a pointed shape protruding from the planar region such that whenever the cap fitting and the inlet fitting are engaged the piercing elements of the planar region are forced into contact with and pierce the pierceable film, thereby allowing driving fluid to enter the interior of the container and to force fluid from the container to enter the inlet port of the inlet.

2. The fluid input module of claim 1 wherein said fluid is a biological sample.

3. The fluid input module of claim 2 wherein said biological sample is selected from the group consisting of blood, saliva, urine, and plasma.

4. The fluid input module of claim 1 wherein there is one inlet port and one outlet port.

5. The fluid input module of claim 1 wherein said pointed shape of said piercing elements is conical or pyramidal.

6. The fluid input module of claim 1 wherein there is one outlet port and a plurality of inlet ports.

7. The fluid input module of claim 1 wherein said container comprises a plurality of compartments each associated with a separate inlet port.

8. The fluid input module of claim 1 wherein said container further includes disposed therein a dried reagent.

9. The fluid input module of claim 1 wherein said container further includes a filter through which said fluid passes after said engagement of said snap-on fittings and said entrance of said driving fluid.

10. The fluid input module of claim 1 further comprising a rigidity plate contacting said pierceable film on a side opposite said planar region of said inlet whenever said cap fitting and said inlet fitting are engaged, the rigidity plate comprising a hole in each position where said piercing element contacts said pierceable film.

11. The fluid input module of claim 10 wherein each of said holes comprises an area and shape that permits said piercing elements to pierce said pierceable film whenever said cap fitting and said inlet fitting are engaged.

12. The fluid input module of claim 1 wherein said cap fitting and said inlet fitting are snap-on fittings, interference fittings, or threaded fittings.
